(19) United States
(12) Patent Application Publication
(10) Pub. No.: US 2005/0136848 A1
(43) Pub. Date: Jun. 23, 2005

(54) Multi-mode audio processors and methods of operating the same

(76) Inventor: Matt Murray, Raleigh, NC (US)

Correspondence Address: Elizabeth A. Stanek;Myers Bigel Sibley & Sajovec, Post Office Box 37428, Raleigh, NC, 27627, US

(21) Appl. No.: 10/743,670

(22) Filed: Dec. 22, 2003

(51) Int. Cl. H04B 1/44; H04B 1/46

(52) U.S. Cl. 455/79; 455/78

(57) ABSTRACT

A portable electronic device is provided that includes a housing and first and second spaced apart transducers positioned in the housing. A multi-mode audio processor circuit is configured to transmit sound from the first transducer in a first mode of operation and to generate a composite audio signal from sound energy received by the first and second transducers in a second mode of operation. Related mobile terminals and methods of operating portable electronic devices are also provided.

### BACKGROUND OF THE INVENTION

The present invention relates to audio systems for personal use, such as in portable electronic devices and, more particularly, to audio processors for use in portable electronic devices.

Manufacturers and designers of portable electronic devices, such as mobile telephones, frequently seek to reduce the overall dimensions of such devices while maintaining attractive style characteristics for the devices. One consequence of the reduced size for such devices is that less space may be available for the required components that provide the necessary functionality of the phone as well as components that provide additional functionality. As the space available for the hardware components decreases in the portable electronic devices, it may become more difficult to support additional functionality.

Conventional mobile telephones typically provide noise cancellation to suppress unwanted background noise and enable the participants in a conversation to comprehend one another. Noise cancellation may be provided by, for example, applying sophisticated noise cancellation algorithms to signals provided by a microphone disposed in the housing of the mobile telephone.

Noise cancellation algorithms may be used in portable electronic devices having a single microphone or multiple microphones. Single microphone devices may include omnidirectional microphones that are designed to detect sound equally in all directions. Noise cancellation algorithms in phones using omnidirectional microphones may have difficulty differentiating between wanted and unwanted noise.

Time delay processing may be used in portable electronic devices having both single and multiple microphones to enhance the cancellation effect of background noise. Furthermore, microphones may be made somewhat directional (bi-directional or uni-directional), i.e., more sensitive to sound coming from a particular direction, by having respective ports to receive sound from respective sides of the microphone. Multiported, directional microphones may provide improvements over single ported omnidirectional microphones, however, may suffer from other problems caused by, for example, wind noise.

Some conventional electronic devices include multiple microphones. These microphones may be directional microphones designed to be more sensitive in certain directions. With multiple microphones, a noise cancellation algorithm can use the known spatial relationship of the microphones to be more selective of which sounds are cancelled and which sounds are amplified. Thus, the use of two or more microphones provides multiple inputs to the noise cancellation algorithm and may increase the directionality of the cancellation algorithm. However, adding additional microphones to the mobile telephone may be problematic due to size limitations of portable electronic devices. Accordingly, improved devices for and methods of noise cancellation may be desired.

### SUMMARY OF THE INVENTION

Embodiments of the present invention provide portable electronic devices including a housing and first and second spaced apart transducers positioned in the housing. A multi-mode audio processor circuit is configured to transmit sound from the first transducer in a first mode of operation and to generate a composite audio signal from sound energy received by the first and second transducers in a second mode of operation.

In some embodiments of the present invention, the multi-mode audio processor circuit may be configured to generate an audio signal from sound energy received by the second transducer in the first mode of operation. The multi-mode audio processor circuit may be further configured to combine first and second audio signals produced from sound energy received by the first and second transducers, respectively, in the second mode of operation to generate a noise-attenuated audio signal.

In further embodiments of the present invention, an audio amplifier may be configured to be coupled to the first transducer in the first mode of operation and a preamplifier may be configured to be coupled to the first transducer in the second mode of operation.

In still further embodiments of the present invention, a switch may be coupled to the first transducer and configured to isolate a path of the audio amplifier from a path of the preamplifier during the first and second modes of operation. The switch may be configured to be in a first position coupled between the first transducer and the audio amplifier in the first mode of operation and to be in a second position coupled between the first transducer and the preamplifier in the second mode of operation.

Some embodiments of the present invention provide a mobile terminal including a housing, a microphone positioned in the housing and a speaker positioned in the housing remote from the microphone. A multi-mode audio processor circuit may be configured to apply noise cancellation to first and second microphone inputs thereof, the first microphone input being coupled to the microphone and the second microphone input being coupled to the speaker.

Further embodiments of the present invention provide a mobile terminal including a multi-mode audio processor circuit operatively associated with a transducer, the multi-mode audio processor circuit being configured to operate the transducer as a speaker during a first mode of operation and a microphone during a second mode of operation.

Some embodiments of the present invention provide a method of operating a mobile terminal including transmitting sound from a first transducer in a first mode of operation and generating a composite audio signal from sound energy received by the first transducer and a second transducer in a second mode of operation.

### BRIEF DESCRIPTION OF THE DRAWINGS

FIG. 1 is a schematic block diagram illustrating mobile terminals including multi-mode audio processing circuits according to some embodiments of the present invention.

FIG. 2 is a schematic block diagram of transducer assemblies operatively associated with multi-mode audio processing circuits according to further embodiments of the present invention.

FIG. 3 is a flow chart illustrating operations of portable electronic devices including multi-mode audio processor circuits according to some embodiments of the present invention.

FIG. 4 is a flow chart illustrating operations of portable electronic devices including multi-mode audio processor circuits according to further embodiments of the present invention.

FIG. 5 is a flow chart illustrating operations of portable electronic devices including multi-mode audio processor circuits according to still further embodiments of the present invention.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood that although the terms first and second are used herein to describe various elements, these elements should not be limited by these terms. These terms are only used to distinguish one element from another element. Thus, a first element discussed below may be termed a second element, and similarly, a second element may be termed a first element without departing from the scope of the present invention. As used herein the term “and/or” includes any and all combinations of one or more of the associated listed items.

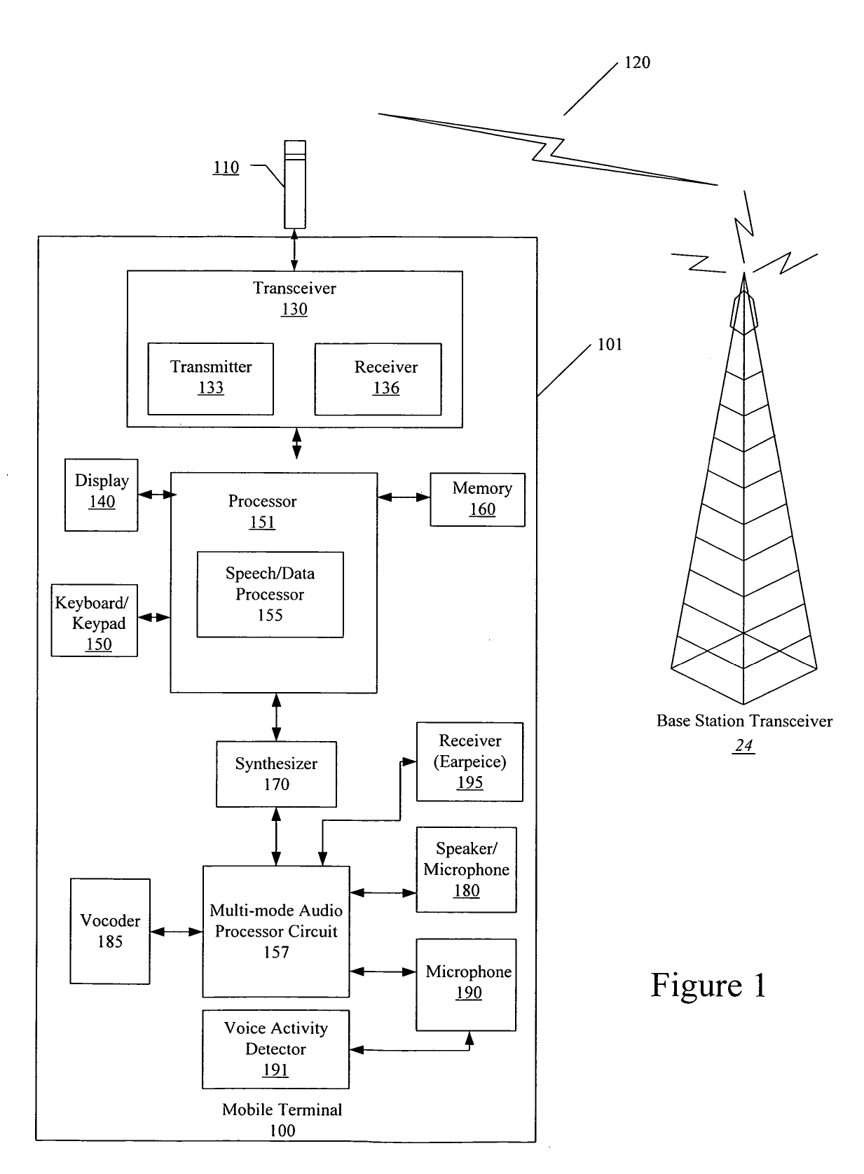

The present invention will be described below with respect to embodiments of the invention illustrated in FIGS. 1 through 5. Embodiments of the present invention provide multi-mode audio processor circuits for use in portable electronic devices, for example, mobile terminals. The multi-mode audio processor circuits are configured to transmit sound from a first transducer in a first mode of operation and to generate a composite audio signal from sound energy received by the first transducer and a second transducer in a second mode of operation. In other words, the first transducer may be configured to operate as a speaker, for example, a loudspeaker, in the first mode of operation and a microphone, for example, a dynamic microphone, in the second mode of operation. Accordingly, portable electronic devices including multi-mode audio processors according to embodiments of the present invention may apply two-microphone noise cancellation or other audio signal processing algorithms without providing two physical microphones in the housing of the portable electronic device. Thus, embodiments of the present invention may provide improved devices and methods for noise cancellation or other audio processing without adding additional components.

Multi-mode audio processor circuits according to embodiments of the present invention may be included in portable electronic devices. It will be understood, that, as used herein, the term “portable electronic device” may include a mobile terminal or a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop portable computer, that may include a radiotelephone transceiver.

Embodiments of the present invention will now be described with reference to the schematic block diagram illustration of a mobile terminal in FIG. 1. FIG. 1 illustrates an exemplary radiotelephone communication system, in accordance with embodiments of the present invention, which includes a mobile terminal 100 configured to communicate with a base station transceiver 24 of a wireless communications network 120. The mobile terminal 100 includes a portable housing 101 and may include a keyboard/keypad 150, a display 140, a vocoder 185, a speaker/microphone 180, a microphone 190, a receiver 195, a voice activity detector 191, a transceiver 130, and a memory 160 that communicate with a processor 151. The transceiver 130 typically includes a transmitter circuit 133 and a receiver circuit 136, which respectively transmit outgoing radio frequency signals to the base station transceiver 24 and receive incoming radio frequency signals, such as voice or other audio signals, from the base station transceiver 24 via an antenna 110. The radio frequency signals 120 transmitted between the mobile terminal 100 and the base station transceiver 24 may comprise both traffic and control signals (e.g., paging signals/messages for incoming calls), which are used to establish and maintain communication with another party or destination.

The processor 151 may support various functions of the mobile terminal 100. For example, as illustrated in FIG. 1, the processor 151 may include a speech/data processing circuit 155. The speech/data processing circuit may be configured to decode received audio signals from the receiver circuit 136 and selectively provide the decoded audio signals to the speaker/microphone 180 and/or receiver 195. In some embodiments of the present invention, the speaker/microphone 180 may be a polyphonic loudspeaker and/or a handsfree speaker, for example, a push to talk speaker. In these embodiments of the present invention, the receiver 195 may be included in the mobile terminal 100 for handset audio reception. It will be understood that some embodiments of the present invention do not include the earpiece receiver 195 illustrated in FIG. 1. In these embodiments of the present invention, the speaker/microphone 180 may also be used for handset audio reception. As further shown in FIG. 1, musical instrument digital interface (MIDI) signals may be supplied to the speaker/microphone 180 by a MIDI synthesizer 170 for polyphonic signals, alerting and/or user feedback. Alternatively, synthesizers for other formats may be provided.

The speech/data processing circuit 155 as well as other functional modules not illustrated in FIG. 1, but which will be understood to those of skill in the art related to wireless communications including both data and voice communication support, may be provided in the processor 151. As used herein, the speech/data processing circuit 155 may include components such as demodulators, decoders, interleavers, encrypters and radio frequency (RF) processor circuitry. The processor 151, such as a microprocessor, microcontroller, or similar data processing device, may execute program instructions stored in a memory 160 of the mobile terminal 100, such as a dynamic random access memory (DRAM), electrically erasable programmable read-only memory (EEPROM) or other storage device.

The transceiver 130, the speech/data processing circuit 155 and other components of the mobile terminal 100 may be implemented using a variety of hardware and software. For example, operations of the transceiver 130 and/or the speech/data processing circuit 155 may be implemented using special-purpose hardware, such as an application specific integrated circuit (ASIC) and programmable logic devices such as gate arrays, and/or software or firmware running on a computing device such as a microprocessor, microcontroller or digital signal processor (DSP). Although functions of the transceiver 130 and the other circuits shown in FIG. 1 may be integrated in a single device, such as a single ASIC microprocessor, they may also be distributed among several devices. Aspects of these circuits may also be combined in one or more devices, such as an ASIC, DSP, microprocessor or microcontroller. These various implementations using hardware, software, or a combination of hardware and software will generally be referred to herein as “circuits.” The foregoing components of the mobile terminal 100 may be included in many conventional mobile terminals and their functionality is generally known to those skilled in the art.

The base station transceiver 24 is typically a radio transceiver(s) that defines an individual cell in a cellular network and communicates with the mobile terminal 100 and other mobile terminals in the cell using a radio-link protocol. Although only a single base station transceiver 24 is shown, it will be understood that many base station transceivers may be connected through, for example, a mobile switching center and other devices to define a wireless communications network.

Although the present invention may be embodied in communication devices or systems, such as the mobile terminal 100, it will be understood that the present invention is not limited to such devices and/or systems. Instead, the present invention may be embodied in any apparatus that may utilize a multi-mode audio processor circuit according to embodiments of the present invention.

In accordance with various embodiments of the present invention, a multi-mode audio processor circuit 157 disposed within the mobile terminal 100 is configured to switch the mobile terminal 100 between a first mode of operation and a second mode of operation. It will be understood that the multi-mode audio processor circuit 157 may include, for example, amplifiers and other electronics to provide operations according to embodiments of the present invention. The multi-mode audio processor circuit 157 may be configured to transmit sound from the speaker/microphone 180 (first transducer), i.e., transmit a signal to a user via the speaker/microphone 180, and to generate an audio signal from sound energy received by the microphone 190 (second transducer) in the first mode of operation. In other words, the speaker/microphone 180 may operate as, for example, a loudspeaker in the first mode of operation and the microphone 190 may operate as, for example, an electret microphone in the first mode of operation. The mobile terminal 100 may operate in the first mode of operation, when the mobile terminal 100 is idle, i.e., waiting for a call, or is receiving a request for a call from the base station 24. The speaker/microphone 180 may be used to provide an alerting tone to notify the user of the call request in the first mode of operation. As discussed above, musical instrument digital interface (MIDI) signals may be supplied to the speaker/microphone 180 by a MIDI synthesizer 170 to provide, for example, polyphonic alerting tones.

Once the call is established and the alerting tones may no longer be active, the multi-mode audio processor circuit 157 may be configured to switch the mobile terminal from the first mode of operation to the second mode of operation. The multi-mode audio processor circuit 157 may be configured to receive sound energy at the speaker/microphone 180 and microphone 190 in the second mode of operation. In other words, the first transducer 180 may operate as a dynamic microphone in the second mode of operation and the second transducer 190 transducer may still operate as an electret microphone in the second mode of operation. The speaker/microphone 180 and microphone 190 receive sound energy and first and second audio signals are produced from the sound energy received by the speaker/microphone 180 and microphone 190. The multi-mode audio processor circuit 157 may be further configured to combine the first and second audio signals to generate a noise-attenuated audio signal. Thus, a composite audio signal may be generated from sound energy received by the speaker/microphone 180 and microphone 190 in the second mode of operation.

In some embodiments of the present invention, the speaker/microphone 180 may operate as both a dynamic speaker and a dynamic microphone during hands-free operation of the handset, for example, using a push-to-talk functionality, when the user is on a call. These embodiments of the present invention may include a voice activity detector 191 coupled to the microphone 190 in the housing of the portable electronic device as illustrated in FIG. 1. Details with respect to these embodiments of the present invention will be discussed further below.

Accordingly, portable electronic devices including multi-mode audio processor circuits 157 according to embodiments of the present invention may apply two-microphone noise cancellation algorithms without providing two physical microphones in the housing of the portable electronic device. In certain embodiments, the speaker/microphone 180 and microphone 190 may have as large a distance as possible between them. The spatial relationship of the speaker/microphone 180 and microphone 190 may be used in the noise cancellation algorithm to be more selective of which sounds are cancelled and which sounds are amplified. For example, the microphone 190 may be positioned closer to where a user's voice originates, for example, close to the user's mouth. Thus, the user's voice (sound energy) will reach the microphone 190 and the speaker/microphone 180 at different times and with different amplitudes. Accordingly, there will be a time delay between when the speaker/microphone 180 and microphone 190 receive the voice signals (sound energy). In contrast, background noise will likely reach the speaker/microphone 180 and microphone 190 at approximately the same time. Thus, the multi-mode audio processor circuit 157 may use the time delays as well as amplitude differences, as well as other characteristics, to determine which signals to amplify and which signals to suppress to provide a composite noise-attenuated audio signal.

It will be understood that two-microphone (multi-microphone) noise cancellation algorithms that use, for example, special relationships, time delay, amplitude differences, spectral characteristics, the characterization of the human voice and the like, to determine which signals to amplify and which signals to suppress are known to those having skill in the art. Accordingly, the details with respect to noise cancellation algorithms will not be discussed further herein. Furthermore, the microphone 190 may be any type of microphone known to those of skill in the art capable of being used in a portable electronic device. For example, the microphone 190 may be, for example, omnidirectional, multidirectional, multiported, condenser, electret, ribbon, dynamic, piezo-type and the like without departing from the scope of the present invention.

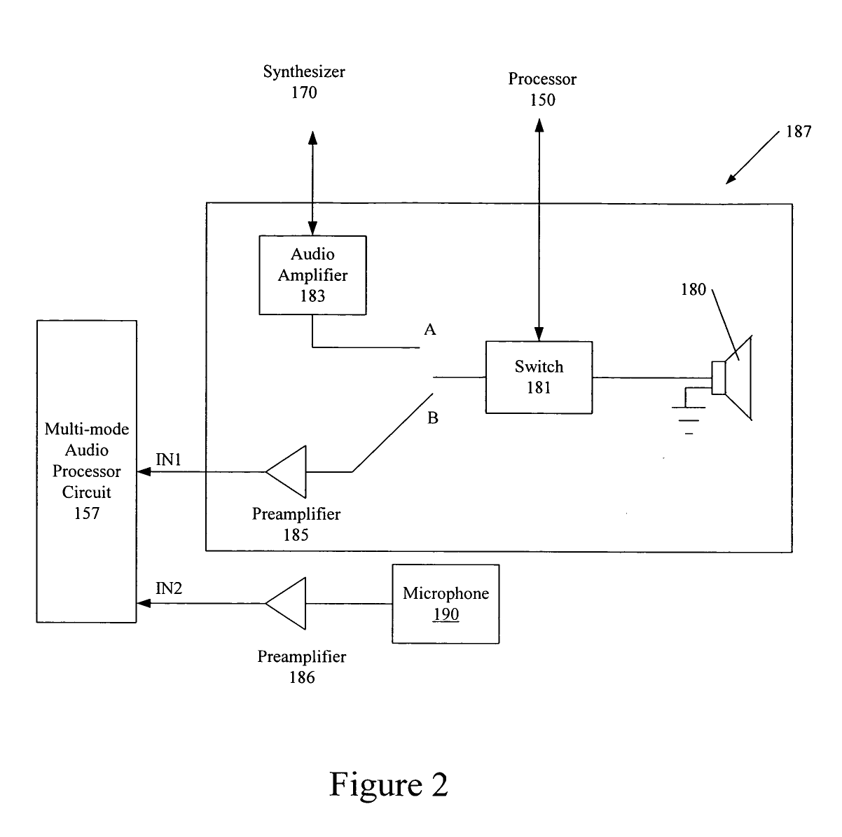

A transducer assembly 187 according to embodiments of the present invention will now be described with reference to the schematic block diagram illustration of FIG. 2. As shown in the embodiments of FIG. 2, the transducer assembly 187 includes a speaker/microphone 180, a switch 181, an audio amplifier 183 and a preamplifier 185. The speaker/microphone 180 may be a dynamic speaker/dynamic microphone. A dynamic loudspeaker typically includes a coil in close proximity to a magnet and a diaphragm. The diaphragm may be, for example, paper or plastic. In particular, a current flowing through the coil in the loudspeaker produces a magnetic field that interacts with a static magnetic field of the magnet associated with the speaker. This interaction causes the coil and the diaphragm attached to the coil to move in relation to the stationary magnet. When the diaphragm moves up and down, it compresses and expands air around it producing sound energy. A dynamic microphone functions very similar to a dynamic speaker, but in reverse. A microphone is a sound sensitive device, like a speaker, that transmits (carries) dialogue, background noise, music, etc. to a recording or amplification system. A dynamic microphone is a microphone where the changing air pressure, i.e., the sound energy, moves the diaphragm (paper or plastic), which moves the coil of wire in the magnetic field of the permanent magnet of the dynamic microphone. Due to the movement of the coil through a magnetic field, an electrical current is produced in the coil of wire that represents the changing air pressure, i.e., the sound energy. Thus, the speaker/microphone 180 according to embodiments of the present invention may be configured to operate as both a speaker and a microphone as discussed above. It will be understood that although the present invention is discussed herein with respect to dynamic speakers and microphones, embodiments of the present invention are not limited to this configuration.

As further illustrated in FIG. 2, the speaker/microphone 180 may be included in a transducer assembly 187 according to embodiments of the present invention. As illustrated, the transducer assembly includes an audio amplifier 183. The audio amplifier 183 is provided to amplify signals before the signals are transmitted to the speaker/microphone 180 during the first mode of operation (speaker). As illustrated, the audio amplifier 183 may amplify an acoustic signal received from the synthesizer 170 or from the downlink voice circuitry of the portable electronic device. The transducer assembly 187 also includes a preamplifier 185. The preamplifier 185 is provided to amplify an acoustic signal received from the speaker/microphone 180 during the second mode of operation. The first preamplifier 185 is further configured to transmit the received acoustic signal to a first microphone input IN1 of the multi-mode audio processor circuit 157 for use in a noise cancellation algorithm. The first preamplifier 185 is configured to receive a low voltage signal, for example, from about 0.1 mV to about 20 mV, amplify that signal and transmit the signal to the processor 151.

As further illustrated in FIG. 2, a second preamplifier 186 may be coupled to the microphone 190. The second preamplifier 186 is provided to amplify an acoustic signal received from the microphone 190 during the second mode of operation. The second preamplifier 186 is further configured to transmit the received acoustic signal to a second microphone input IN2 of the multi-mode audio processor circuit 157 for use in the noise cancellation algorithm.

A switch 181 is also provided to isolate a path of the audio amplifier 183 from a path of the first preamplifier 185. As illustrated in FIG. 2, when the switch 181 is in a first position A, the audio amplifier 183 is coupled to speaker/microphone 180 and the preamplifier 185 is decoupled from the speaker/microphone 180 (first mode). In contrast, when the switch is in a second position B, the preamplifier 185 is coupled to the speaker/microphone 180 and the audio amplifier 183 is decoupled from the speaker/microphone 180 (second mode). As illustrated in FIG. 2, operations of the switch may be controlled by the multi-mode audio processor circuit 157 in the processor 151 as discussed above with respect to FIG. 1. It will be understood that embodiments of the transducer assembly 187 illustrated in FIG. 2 are provided for exemplary purposes only and that embodiments of the present invention are not limited to this configuration.

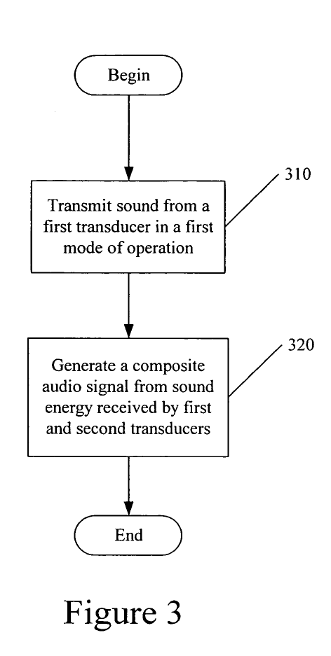

Referring now to FIG. 3, operations of a personal electronic device including a multi-mode audio processor circuit according to embodiments of the present invention will be discussed. Operations begin at block 310 by transmitting sound from a first transducer during a first mode of operation. During the first mode of operation, the first transducer may operate as a speaker, for example, a dynamic loudspeaker. The transducer may be included in a portable electronic device, for example, a mobile terminal. In these embodiments, the transducer may operate in the first mode of operation when the mobile terminal is idle, i.e., not receiving a request for a call, or when a call is being received.

A composite audio signal may be generated from sound energy received by the first transducer and a second transducer (block 320) in the second mode of operation. The first and second transducers are configured to operate as microphones during the second mode of operation. The mobile terminal may operate in the second mode of operation when a call request to the mobile terminal is accepted by a user of the mobile terminal. In some embodiments of the present invention, a multi-mode audio processor circuit may be configured to receive sound energy/audio signals from the first and second transducers at first and second microphone inputs, respectively, and generate the composite audio signal from sound energy received by the first and second transducers in a second mode of operation. Accordingly, a two-microphone noise cancellation algorithm may be provided in mobile terminals having only one physical microphone, thereby possibly providing room in the housing of the mobile terminal for optional functionality.

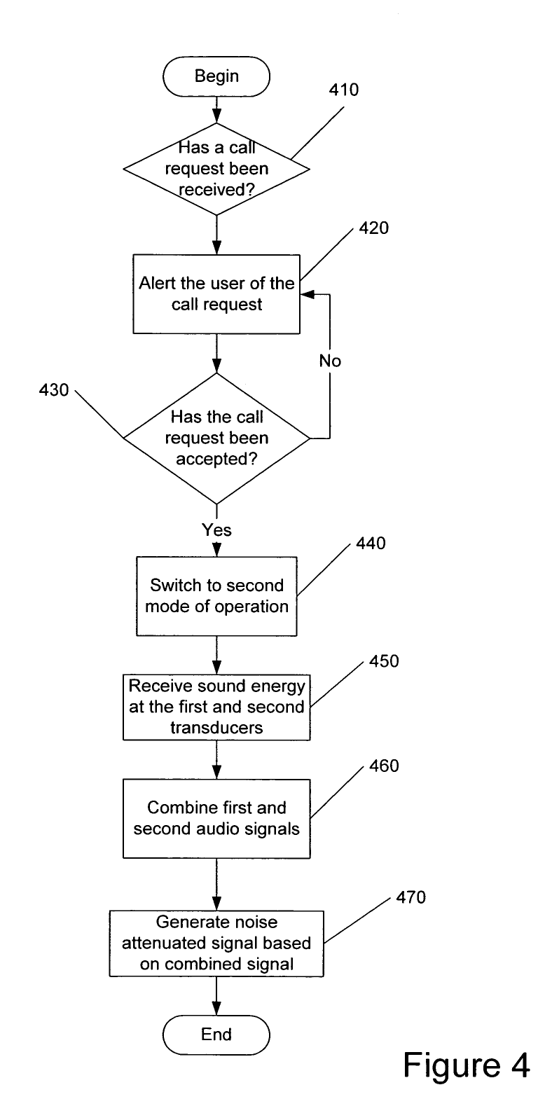

Referring now to FIG. 4, operations of portable electronic devices including multi-mode audio processor circuits according to further embodiments of the present invention will be discussed. Operations begin at block 410 by determining if a call request has been received at a portable electronic device, for example, a mobile terminal. If a call request has not been received, the mobile terminal may remain idle until a call request is received by the mobile terminal. If, on the other hand, a call request has been received by the mobile terminal, the user is alerted of the call request using a first transducer in the first mode of operation (block 420). It is determined if the call requested has been accepted at the mobile terminal (block 430). If the call request has not been accepted, the mobile terminal may continue alerting the user (block 420) until the call is accepted or the call request has been terminated. If the call request has been accepted, the mobile terminal is switched from the first mode of operation to a second mode of operation (block 440).

Sound energy may be received at the first and second transducers in the second mode of operation (block 450). It will be understood that the first and second transducers may receive the sound energy created by, for example, a human voice, at different times and with different amplitudes, as one of the transducers may be positioned closer to the source of the sound energy, for example, a user's mouth. A multi-mode audio processor circuit may receive the sound energy from the first and second transducers at first and second microphone inputs, respectively, and combine first and second audio signals produced from the sound energy received by the first and second transducers, respectively, in the second mode of operation (block 460). A single noise-attenuated audio signal may be generated based on the combined first and second audio signals (block 470).

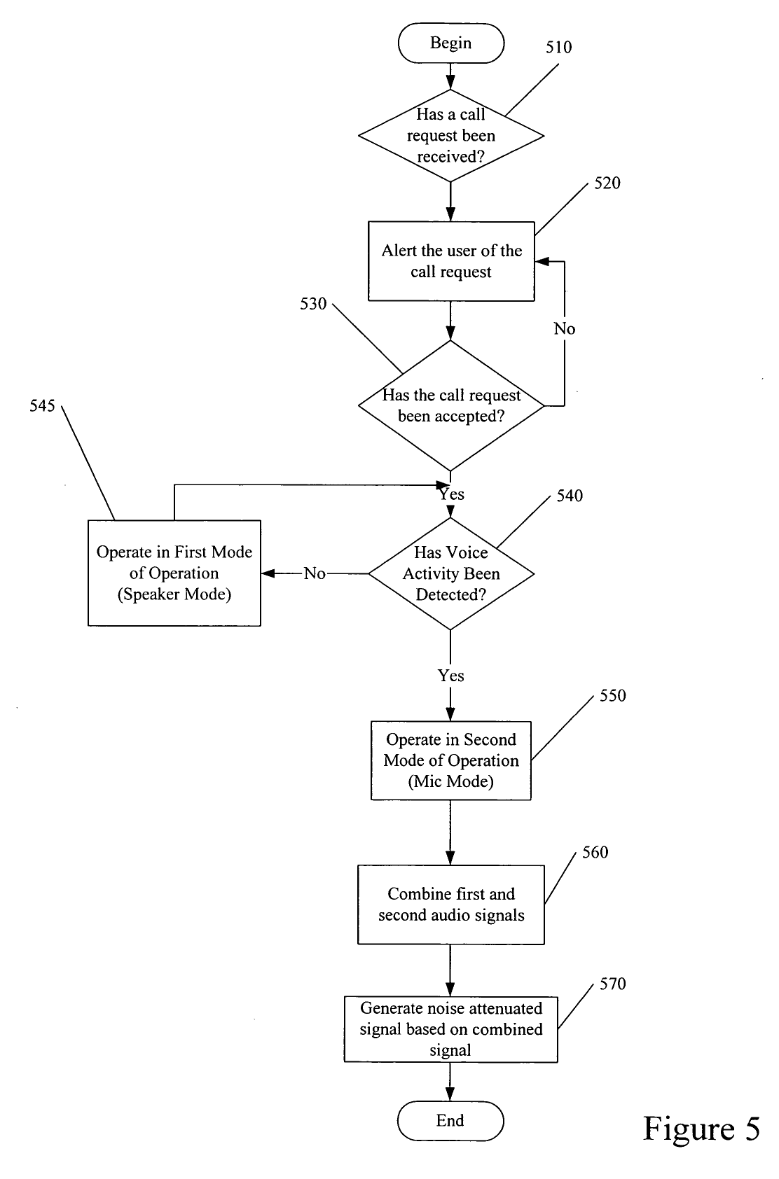

Referring now to FIG. 5, operations of portable electronic devices including multi-mode audio processor circuits according to still further embodiments of the present invention will be discussed. Operations begin at block 510 by determining if a call request has been received at a portable electronic device, for example, a mobile terminal. If a call request has not been received, the mobile terminal may remain idle until a call request is received by the mobile terminal. If, on the other hand, a call request has been received by the mobile terminal, the user is alerted of the call request using a first transducer in the first mode of operation (block 520). It is determined if the call requested has been accepted at the mobile terminal (block 530). If the call request has not been accepted, the mobile terminal may continue alerting the user (block 520) until the call is accepted or the call request has been terminated. If the call request has been accepted, the mobile terminal may determine if voice activity is detected (block 540). Voice activity may be detected by, for example, voice activity detector 191 coupled to the microphone 190 as illustrated in FIG. 1. In these embodiments of the present invention the speaker/microphone may operate as both a dynamic speaker and a dynamic microphone when a user is on a call using, for example, hands-free operation of the mobile terminal such as push-to-talk functionality.

If voice activity is detected (block 540) above a certain threshold at the microphone, the speaker/microphone may be configured to operate as a microphone (block 550). Sound energy may be received at the microphone and the speaker/microphone in the second mode of operation. It will be understood that the microphone and speaker/microphone (first and second transducers) may receive the sound energy created by, for example, a human voice, at different times and with different amplitudes, as one of the transducers may be positioned closer to the source of the sound energy, for example, a user's mouth. A multi-mode audio processor circuit may receive the sound energy from the first and second transducers at first and second microphone inputs, respectively, and combine first and second audio signals produced from the sound energy received by the first and second transducers, respectively, in the second mode of operation (block 560). A single noise-attenuated audio signal may be generated based on the combined first and second audio signals (block 570). On the other hand, when voice activity is not detected at the microphone (block 540), the speaker/microphone may operate as a speaker in the first mode of operation (block 545) and the path of the microphone may be disabled until voice activity is detected.

As discussed briefly above with respect to FIGS. 1 through 5, portable electronic devices including multi-mode audio processor circuits according to embodiments of the present invention may apply two-microphone noise cancellation algorithms without providing a second physical microphone in the housing of the portable electronic device. Accordingly, devices including multi-mode audio processor circuits according to embodiments of the present invention may provide improved noise cancellation without causing the overall size of the housing to increase. Furthermore, the use of dynamic microphones may provide reduced interference with, for example, antennae, relative to electret microphones.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A portable electronic device, comprising:
a housing;
first and second spaced apart transducers positioned in the housing; and
a multi-mode audio processor circuit configured to transmit sound from the first transducer in a first mode of operation and to generate a composite audio signal from sound energy received by the first and second transducers in a second mode of operation.

2. The device of claim 1 wherein the multi-mode audio processor circuit is configured to generate an audio signal from sound energy received by the second transducer in the first mode of operation.

3. The device of claim 1 wherein the multi-mode audio processor circuit is further configured to combine first and second audio signals produced from sound energy received by the first and second transducers, respectively, in the second mode of operation to generate a noise-attenuated audio signal.

4. The device of claim 1 further comprising:
an audio amplifier configured to be coupled to the first transducer in the first mode of operation; and
a preamplifier configured to be coupled to the first transducer in the second mode of operation.

5. The device of claim 4, further comprising a switch coupled to the first transducer and configured to isolate a path of the audio amplifier from a path of the preamplifier during the first and second modes of operation, the switch being configured to be in a first position coupled between the first transducer and the audio amplifier in the first mode of operation and to be in a second position coupled between the first transducer and the preamplifier in the second mode of operation.

6. A mobile terminal comprising:
a housing;
a microphone positioned in the housing;
a speaker positioned in the housing remote from the microphone; and
a multi-mode audio processor circuit configured to apply noise cancellation to first and second microphone inputs thereof, the first microphone input being coupled to the microphone and the second microphone input being coupled to the speaker.

7. The mobile terminal of claim 6 wherein the speaker comprises a transducer and wherein the multi-mode audio processor circuit is configured to transmit sound from the transducer in a first mode of operation and to generate a composite audio signal from sound energy received by the microphone and the transducer in a second mode of operation.

8. The mobile terminal of claim 7 wherein the multi-mode audio processor circuit is configured to generate an audio signal from sound energy received by the microphone in the first mode of operation.

9. The mobile terminal of claim 7 wherein the multi-mode audio processor circuit is further configured to combine first and second audio signals produced from sound energy received by the microphone and the transducer, respectively, in the second mode to generate a noise-attenuated audio signal.

10. The mobile terminal of claim 7 further comprising:
an audio amplifier configured to be coupled to the transducer in the first mode of operation; and
a preamplifier configured to be coupled to the transducer in the second mode of operation.

11. The mobile terminal of claim 10, further comprising a switch coupled to the first transducer and configured to isolate a path of the audio amplifier from a path of the preamplifier during the first and second modes of operation, the switch being configured to be in a first position coupled between the first transducer and the audio amplifier in the first mode of operation and to be in a second position coupled between the first transducer and the preamplifier in the second mode of operation.

12. A mobile terminal comprising a multi-mode audio processor circuit operatively associated with a transducer, the multi-mode audio processor circuit being configured to operate the transducer as a speaker during a first mode of operation and a microphone during a second mode of operation.

13. The mobile terminal of claim 12 wherein the transducer comprises a first transducer, the mobile terminal further comprising:
a housing, the first transducer being positioned in the housing; and
a second transducer positioned in the housing and spaced apart from the first transducers, wherein the multi-mode audio processor circuit is further configured to transmit sound from the first transducer in a first mode of operation and to generate a composite audio signal from sound energy received by the first and second transducers in a second mode of operation.

14. The mobile terminal of claim 13 wherein the multi-mode audio processor circuit is configured to generate an audio signal from sound energy received by the second transducer in the first mode of operation.

15. The mobile terminal of claim 13 wherein the multi-mode audio processor circuit is further configured to combine first and second audio signals produced from sound energy received by the first and second transducers, respectively, in the second mode to generate a noise-attenuated audio signal.

16. The mobile terminal of claim 13 further comprising:
an audio amplifier configured to be coupled to the first transducer in the first mode of operation; and
a preamplifier configured to be coupled to the first transducer in the second mode of operation.

17. The mobile terminal of claim 16, further comprising a switch coupled to the first transducer and configured to isolate a path of the audio amplifier from a path of the preamplifier during the first and second modes of operation, the switch being configured to be in a first position coupled between the first transducer and the audio amplifier in the first mode of operation and to be in a second position coupled between the first transducer and the preamplifier in the second mode of operation.

18. A method of operating a mobile terminal, comprising:
transmitting sound from a first transducer in a first mode of operation; and
generating a composite audio signal from sound energy received by the first transducer and a second transducer in a second mode of operation.

19. A method according to claim 18, further comprising:
operating the mobile terminal in the first mode of operation when the mobile terminal is idle or receiving a call; and
operating the mobile terminal in the second mode of operation when the mobile terminal is on a call.

20. A method according to claim 18, further comprising:
operating the mobile terminal in the first mode of operation when the mobile terminal is idle or receiving a call;
operating the mobile terminal in the first mode of operation when the mobile terminal is on a call when voice activity has not been detected;
operating the mobile terminal in the second mode of operation when the mobile terminal is on a call when voice activity has been detected.

21. The method of claim 18 wherein transmitting sound from first transducer is preceded by:
receiving a call request at the mobile terminal from a base station, wherein transmitting sound from a first transducer comprises alerting a user of the mobile terminal of the call request using the first transducer as a speaker in the first mode of operation.

22. The method of claim 21 further comprising:
determining if the call request has been accepted at the mobile terminal; and
switching the mobile terminal from the first mode of operation to the second mode of operation if the call has been accepted at the mobile terminal.

23. The device of claim 22 wherein generating a composite signal further comprises:
combining the first and second audio signals produced from sound energy received by the first and second transducers, respectively, in the second mode of operation; and
generating a noise-attenuated audio signal based on the combination of the first and second audio signals.
